(19) United States
(12) Patent Application Publication
(10) Pub. No.: US 2013/0270368 A1
(43) Pub. Date: Oct. 17, 2013

(54) FUEL INJECTION VALVE

(71) Applicant: Tatsuo Kobayashi, Susono-shi (JP)

(72) Inventor: Tatsuo Kobayashi, Susono-shi (JP)

(73) Assignee: TOYOTA JIDOSHA KABUSHIKI KAISHA, Toyota-shi, Aichi-ken (JP)

(21) Appl. No.: 13/992,786

(22) PCT Filed: Dec. 20, 2010
(86) PCT No.: PCT/JP2010/072935

§ 371 Date: Jun. 10, 2013

(51) Int. Cl. F02M 61/16

(52) U.S. Cl. CPC F02M 61/163
USPC 239/489

(57) ABSTRACT

A fuel injection valve 1 includes: a nozzle body 10 having a nozzle hole 11 formed at the tip thereof; a needle 20 that is slidably provided in the nozzle body 10, forms a fuel introduction path 21 between the needle 20 and the nozzle body 10, and is seated on a seat portion 12 in the nozzle body 10; a pressure chamber 13 that stores fuel introduced through the fuel introduction path 21; a relay chamber 50 that is located closer to the base end side than the seat portion 12 is, and closer to the tip side than the pressure chamber 13 is; a first helical fuel passage 60 that connects the pressure chamber 13 to the relay chamber 50, and applies a flow to fuel, the flow swirling around an axis A of the needle 20; and second helical fuel passages 70 that connect the relay chamber 50 to a seat space 15 that is formed between the seat portion 12 and the needle 20 when the needle 20 is lifted up.

### TECHNICAL FIELD

The present invention relates to a fuel injection valve.

### BACKGROUND ART

In recent years, in the field of internal combustion engines, active researches have been conducted on supercharged lean burning, and on mass EGR and premixed hypergolic combustion, to achieve CO₂ reductions and emission reductions. To obtain maximum effects of CO₂ reductions and emission reductions, a stable combustion state needs to be formed at a point closer to the combustion limit. While depletion of petroleum-based fuel is becoming more serious, robustness is required in achieving stable combustion with various kinds of fuels such as biofuels. The most important point in achieving such stable combustion is to reduce ignition variation in air-fuel mixtures, and to conduct fast combustion and burn out fuel in the expanding stroke.

In fuel supplies to internal combustion engines, an in-cylinder injection method for injecting fuel directly into a combustion chamber is used to improve excessive responsiveness, increase volumetric efficiency through latent heat of vaporization, and achieve greatly retarded combustion for activating catalysts at low temperatures. However, the use of an in-cylinder injection method has increased oil dilution caused by a fuel spray that remains in the form of liquid droplets and collides with the combustion chamber wall, and has also increased combustion fluctuations due to spray deterioration caused by the deposit formed with liquid fuel around the nozzle hole of an injection valve.

To take measures against the oil dilution and the spray deterioration caused by the use of such an in-cylinder injection method, and to achieve stable combustion by reducing ignition variation, it is essential to atomize the fuel spray so that the fuel in the combustion chamber is promptly vaporized.

A fuel spray injected from a fuel injection valve is atomized by a known technique such as a technique using the shearing force of a thinned liquid film, a technique using cavitation that occurs due to peeling caused by a flow, or a technique of atomizing fuel adhering to a surface due to mechanical vibration of ultrasonic waves. In a fuel injection valve that atomizes a fuel spray as disclosed in Patent Document 1, a swirling flow generating unit having a helical groove formed in the needle applies a strong swirling flow to the fuel to be injected, so that the pressure at the center of the swirling flow is lowered, and air is supplied to the center of the swirling flow. As air is supplied to the swirling flow of the fuel, microscopic bubbles are formed, and bubble fuel that contains the microscopic bubbles is injected. The fuel spray is then atomized by virtue of energy generated from bursting of the microscopic bubbles after the injection.

Patent Document 2 discloses an injection valve that provides fuel with a swirling component through a helical passage formed in the valve portion of the injection valve, disperses the fuel by spreading a fuel spray more widely, and facilitates the mixing of the fuel with air. Patent Document 3 discloses injection of fuel that contains bubbles formed by using the pressure difference between a bubble forming flow passage and a bubble holding flow passage, and atomization of the fuel by virtue of energy generated from bursting of the bubbles in the fuel after the injection.

### PRIOR ART DOCUMENTS

### Patent Documents

[Patent Document 1] International Patent Application No. PCT/JP2010/056372

[Patent Document 2] Japanese Patent Application Publication No. 10-141183

[Patent Document 3] Japanese Patent Application Publication No. 2006-177174

### SUMMARY OF THE INVENTION

### Problems to be Solved by the Invention

As described above, bubble fuel that contains microscopic bubbles can be formed by applying a strong swirling flow to the fuel to be injected and supplying air to the center of the swirling flow. In the bubble fuel, the fuel spray is atomized by bursting of the bubbles. While the fuel is passing through a helical passage in the nozzle body, a swirling flow generating unit applies the strong swirling flow to the fuel. However, the fuel passing through the flow passage for generating the swirling flow is subjected to flow passage resistance, and pressure loss occurs. As a result, the flow speed becomes lower. At a start of activation when fuel pressure is low, such a high flow speed as to generate a swirling flow cannot be achieved, and microscopic bubbles cannot be formed. Therefore, the fuel spray cannot be atomized.

In view of the above circumstances, the present invention has an object to provide a fuel injection valve that atomizes fuel by applying a swirling flow to the fuel immediately after activation and forming a fuel spray that contains microscopic bubbles.

### Means for Solving the Problems

To solve the above problem, a fuel injection valve of the present invention comprises: a nozzle body having a nozzle hole at a tip thereof; a needle slidably provided in the nozzle body and seated on a seat portion in the nozzle body, a fuel introduction path being formed between the needle and the nozzle body; a pressure chamber storing fuel introduced through the fuel introduction path; a relay chamber located closer to a base end side than the seat portion is, and closer to a tip side than the pressure chamber is; a first fuel passage connecting the pressure chamber to the relay chamber and applying a flow to the fuel, the flow swirling around the needle, the first fuel passage having a helical form; and second fuel passages connecting the relay chamber to a seat space formed between the seat portion and the needle when the needle is lifted up, the second fuel passages having a helical form.

As the relay chamber is provided between the first fuel passage and the second fuel passages that have helical forms, the helical passage for applying a swirling flow to fuel can be shortened. As a result, pressure loss of the fuel passing through the passage decreases, and accordingly, the decrease in the flow speed of the swirling flow to be supplied into the nozzle hole can be reduced. Thus, even at the time of activation when fuel pressure is low, a strong swirling flow can be generated, and fuel that contains microscopic bubbles can be injected. Also, as the pressure loss of fuel decreases, driving loss of the pump that pumps out fuel also decreases. Thus, the costs for increasing the fuel pressure can be lowered.

### Effects of the Invention

Having a relay chamber in a helical fuel passage, a fuel injection valve of the present invention reduces the decrease in the flow speed of the swirling flow to be supplied into a nozzle hole. Thus, even at the time of activation when fuel pressure is low, a strong swirling flow can be generated, and fuel that contains microscopic bubbles can be injected.

### BRIEF DESCRIPTION OF THE DRAWINGS

FIG. 1 is an explanatory diagram schematically showing the structure of a fuel injection valve in section;

FIG. 2 is an explanatory diagram showing an enlarged view of the tip portion of the fuel injection valve shown in FIG. 1;

FIG. 3 is an explanatory diagram showing the external appearance of the swirling flow generating member;

FIG. 4 is an explanatory diagram of the swirling flow generating member viewed from the direction of the arrow B shown in FIG. 3;

FIG. 5 is an explanatory diagram showing an enlarged view of the first fuel passage;

FIG. 6 is an explanatory diagram showing an enlarged view of a second fuel passage;

FIG. 7 is an explanatory diagram showing the tip of a fuel injection valve of a comparative example in section;

FIG. 8 is an explanatory diagram showing actual values and expected values with respect to the relationship between quantity of injected fuel and injection time of the fuel injection valve of the comparative example;

FIG. 9 is an explanatory diagram showing a fuel spray from the fuel injection valve of the comparative example

FIG. 10 is an explanatory diagram showing an enlarged view of a helical groove formed in a swirling flow generating member of a second embodiment;

FIG. 11 is an explanatory diagram of the swirling flow generating member viewed from the tip side;

FIG. 12 is an explanatory diagram showing the external appearance of a swirling flow generating member of a third embodiment;

FIG. 13 is an explanatory diagram showing a cross-section taken along the line H-H defined in FIG. 12;

FIG. 14 is an explanatory diagram of the swirling flow generating member viewed from the direction of the arrow J shown in FIG. 12;

FIG. 15 is an explanatory diagram showing the tip portion of a fuel injection valve of the third embodiment in section;

FIG. 16 is an explanatory diagram showing a further enlarged view of the seat space shown in FIG. 15; and

FIG. 17 is an explanatory diagram showing the cross-sectional shape of a helical groove in the tapered portion of a swirling flow generating member of another embodiment.

### MODES FOR CARRYING OUT THE INVENTION

The following is a detailed description of modes for carrying out the invention, with reference to the accompanying drawings.

### First Embodiment

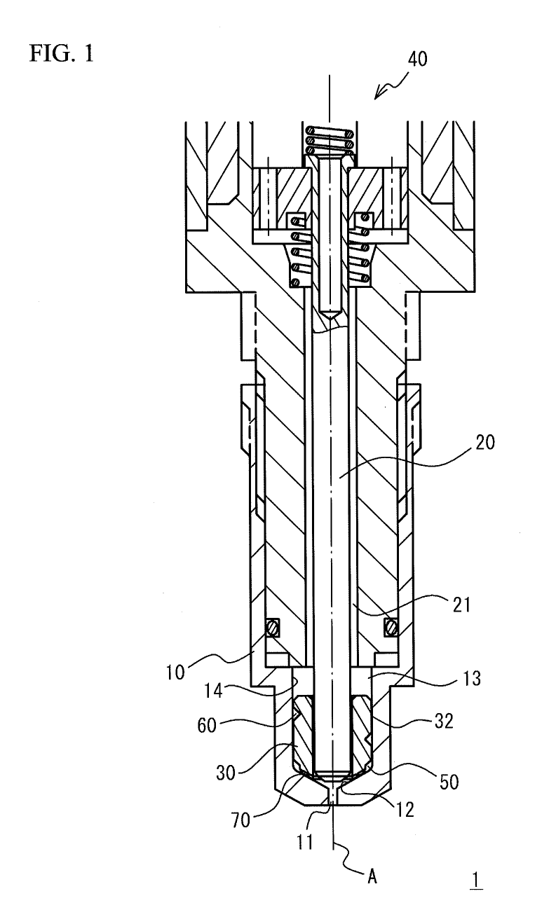

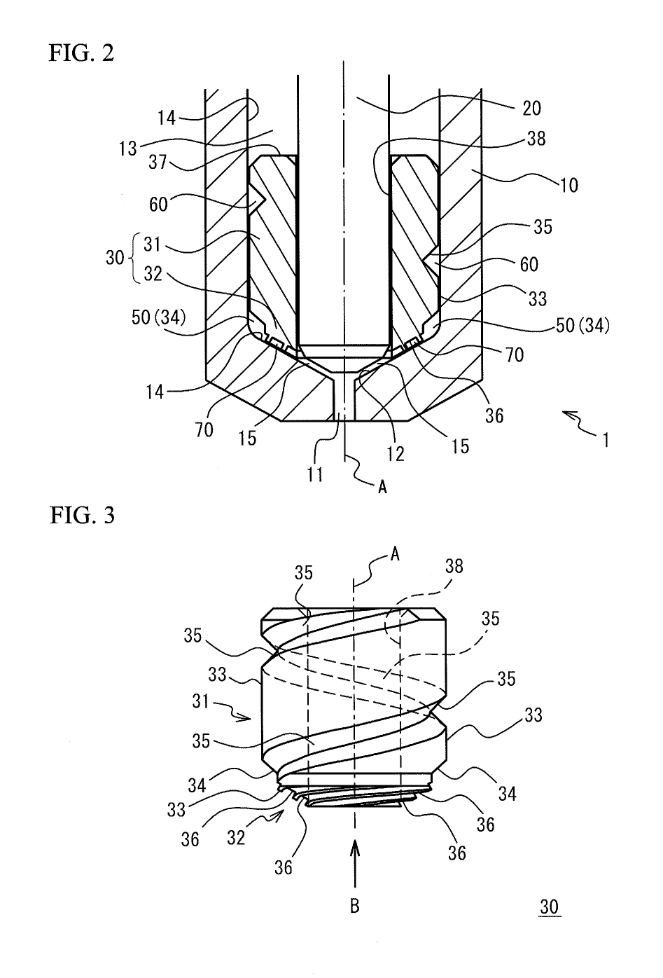

The internal structure of a fuel injection valve 1 according to a first embodiment of the present invention is described in detail. FIG. 1 is an explanatory diagram schematically showing the structure of the fuel injection valve 1 in section. FIG. 2 is an explanatory diagram showing an enlarged view of the tip portion of the fuel injection valve 1 shown in FIG. 1. The fuel injection valve 1 includes a nozzle body 10, a needle 20, and a swirling flow generating member 30. In the following description, the tip side means the moving direction at the time of closing of the needle 20, or means the lower side in the drawing. The base end side means the moving direction at the time of lifting of the needle 20, or the upper side in the drawing.

The nozzle body 10 is a hollow cylindrical member. A nozzle hole 11 is formed at the tip of the nozzle body 10. The nozzle hole 11 is formed in the direction extending along an axis A. A seat portion 12 on which the needle 20 is seated is provided in the nozzle body 10. The nozzle body 10 is designed to accommodate the swirling flow generating member 30 on the tip side. The inner diameter of the nozzle body 10 continuously becomes smaller in the direction from the seat portion 12 toward the nozzle hole 11 in a tapered manner.

The needle 20 is slidably provided in the nozzle body 10. The needle 20 forms a fuel introduction path between the needle 20 and the nozzle body 10, and is seated on the seat portion 12 in the nozzle body 10. The sliding direction of the needle 20 matches the direction of the axis A, and the axis A matches the central axis of the needle 20.

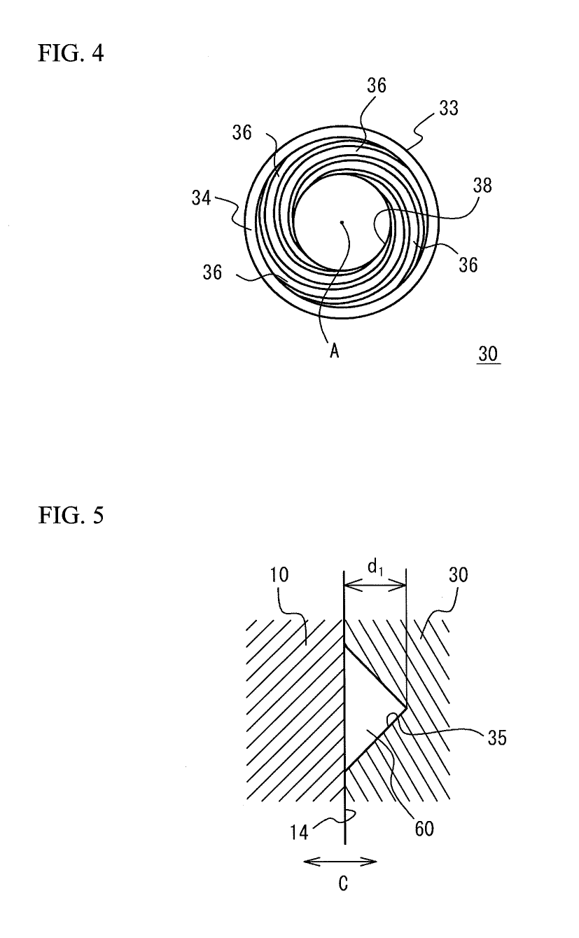

The swirling flow generating member 30 is a member in the form of a hollow cylinder. The swirling flow generating member 30 is incorporated into the inside of the nozzle body 10, and is pushed in and secured. FIG. 3 is an explanatory diagram showing the external appearance of the swirling flow generating member 30. FIG. 4 is an explanatory diagram showing the swirling flow generating member 30 viewed from the direction of the arrow B shown in FIG. 3. The swirling flow generating member 30 includes a cylinder portion 31 having a constant diameter, and a tapered portion 32 having a diameter that becomes smaller in the direction toward the tip. The tapered portion 32 is positioned closer to the tip side than the cylinder portion 31 is. A notch 34 is formed in the outer circumferential surface 33 of the swirling flow generating member 30. The notch 34 is formed in a position equivalent to the boundary between the cylinder portion 31 and the tapered portion 32. The notch 34 is formed along an entire circumference of the axis A. On the outer circumferential surface 33 of the cylinder portion 31, a helical groove 35 is formed in such a manner as to spiral around the axis A. Also, on the outer circumferential surface 33 of the tapered portion 32, helical grooves 36 are formed in such a manner as to spiral around the axis A. More than one helical groove 35 may be formed, but only one helical groove 35 is formed in this embodiment. The number of helical groove 36 should be larger than the number of helical grooves 35. Preferably, three or more helical grooves 36 should be formed. In this embodiment, four helical grooves 36 are formed.

As shown in FIG. 1, the base end side 37 of the swirling flow generating member 30 and the inner circumferential surface 14 of the nozzle body 10 form a pressure chamber 13. A fuel introduction path 21 is connected to this pressure chamber 13. The pressure chamber 13 stores fuel introduced through the fuel introduction path 21.

The fuel injection valve 1 further includes a relay chamber 50, a first fuel passage 60, and second fuel passages 70. As shown in FIG. 2, the notch 34 and the inner circumferential surface 14 of the nozzle body 10 form the relay chamber 50. The pressure chamber 13 is located closer to the base end side than the swirling flow generating member 30 is, and the seat portion 12 is located closer to the tip side than the tapered portion 32 is. Therefore, the relay chamber 50 is located closer to the base end side than the seat portion 12 is, and closer to the tip side than the pressure chamber 13 is.

The helical groove 35 and the inner circumferential surface 14 of the nozzle body 10 form the first fuel passage 60. The first fuel passage 60 is a helical passage that connects the chamber pressure 13 to the relay chamber 50. Accordingly, a flow that swirls around the needle 20 is applied to fuel. The first fuel passage 60 is designed to have a triangular cross-section. Particularly, the bottom side of the triangular cross-section is located far away from the axis A. Since only one helical groove 35 is formed in the cylinder portion 31 of the swirling flow generating member 30, one first fuel passage 60 is formed in this embodiment. As only one first fuel passage 60 is formed, a large flow passage cross-sectional area is formed to supply fuel necessary for injection. More than one first fuel passage 60 may be formed.

The helical grooves 36 and the inner circumferential surface 14 of the nozzle body 10 form the second fuel passages 70. The second fuel passages 70 are helical passages that connect the relay chamber 50 to a seat space 15 that is formed between the seat portion 12 and the needle 20 when the needle 20 is lifted up. Accordingly, the second fuel passages 70 also apply a flow swirling around the needle 20 to fuel. The second fuel passages 70 have a rectangular cross-section. More than one second fuel passage 70 can be formed. Particularly, the number of second fuel passages 70 is larger than the number of first fuel passages 60. Since the four helical grooves 36 are formed in the tapered portion 32 of the swirling flow generating member 30, four second fuel passages 70 are formed in this embodiment.

As the helical grooves 35 and 36 are formed in the swirling flow generating member 30 provided in the nozzle body 10 as described above, the first fuel passage 60 and the second fuel passages 70 can be easily formed. Accordingly, productivity can be increased, and production costs can be lowered. Meanwhile, the needle 20 slidably penetrates through the inner circumferential surface 38 of the swirling flow generating member 30. Accordingly, the inner circumferential surface 38 of the swirling flow generating member 30 functions as a needle guide that guides the needle 20.

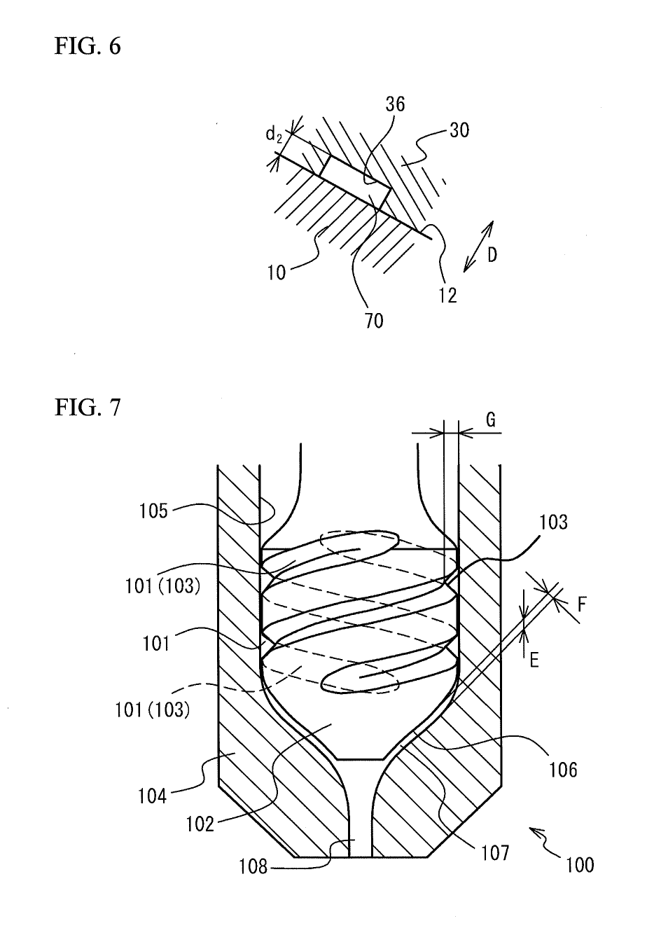

Next, the first fuel passage 60 and the second fuel passages 70 are described in greater detail. FIG. 5 is an explanatory diagram showing an enlarged view of the first fuel passage 60. FIG. 6 is an explanatory diagram showing an enlarged view of one of the second fuel passages 70. In each of FIGS. 5 and 6, fuel flows forward from behind the plane of the drawing. A comparison between FIG. 5 and FIG. 6 shows that the second fuel passage 70 has a smaller width in a direction extending away from the center of rotation of the swirling flow of fuel than the first fuel passage 60. Here, the direction extending away from the center of rotation of the swirling flow of fuel is the direction indicated by the arrow C in FIG. 5, and is the direction indicated by the arrow D in FIG. 6. The direction of the arrow C and the direction of the arrow D are both perpendicular to the inner circumferential surface 14 of the nozzle body 10. It should be noted that “being perpendicular” entails a range equivalent to manufacturing errors, and does not exclusively mean being perfectly perpendicular. Further, as the fact that the second fuel passage 70 has a smaller width in the direction extending away from the center of rotation of the swirling flow of fuel than the first fuel passage 60 is taken into account, this embodiment can be described as follows. That is, the helical grooves 36 forming the second fuel passages 70 are shallower than the helical groove 35 forming the first fuel passage 60 (d₁>d₂). The groove depth d₂ of the helical grooves 36 is designed to be equal to the seat space 15 at the time of maximum lifting of the needle 20.

The fuel injection valve 1 further includes a drive mechanism 40. The drive mechanism 40 controls sliding movement of the needle 20. The drive mechanism 40 is a conventionally-known mechanism that includes components suitable for moving the needle 20, such as an actuator formed with a piezoelectric element or an electromagnet and an elastic member for applying appropriate pressure to the needle 20. As the drive mechanism 40 lifts up the needle 20 toward the base end side, the needle 20 moves away from the seat portion 12. As a result, fuel is supplied into the seat space 15, and the fuel passage leading to the nozzle hole 11 opens. As the fuel passage to the nozzle hole 11 opens, the fuel in the first fuel passage 60, the relay chamber 50, and the second fuel passages 70, which connect the pressure chamber 13 to the nozzle hole 11, is released and flows into the nozzle hole 11.

Next, the flow of fuel in the fuel injection valve 1, and fuel injection are described. The fuel stored in the pressure chamber 13 flows into the first fuel passage 60. As the first fuel passage 60 spirals around the axis A, a flow swirling around the axis A is applied to the fuel passing through the first fuel passage 60. As a result, a swirling flow of fuel is generated. The swirling component the first fuel passage 60 gives to the fuel determines the swirling speed of the fuel.

The fuel that has passed through the first fuel passage 60 flows into the relay chamber 50. The relay chamber 50 stabilizes the swirling flow generated in the fuel having passed through the first fuel passage 60. Since the relay chamber 50 is formed along an entire circumference of the axis A, the fuel spreads over the entire circumference of the axis A, and the swirling flow becomes uniform over the entire circumference of the axis A.

The swirling flow stabilized in the relay chamber 50 then flows into the second fuel passages 70. As the second fuel passages 70 are also designed to have a helical form, a swirling flow is further applied to the fuel passing through the second fuel passages 70. The swirling flow of the fuel having passed through the second fuel passages 70 is then supplied into the seat space 15. Since the inside of the nozzle body 10 becomes continuously smaller in the direction from the seat portion 12 toward the nozzle hole 11 in a tapered manner, the flow passage of fuel is narrowed, and the fuel flows faster. As a result, the swirling flow of fuel is made faster, and a strong swirling flow is formed in the nozzle hole 11. Negative pressure then appears near the center of rotation of the swirling flow, or near the axis A. As the negative pressure is generated, the air outside the nozzle body is sucked into the nozzle body, and an air column appears in the nozzle hole 11. Air bubbles are generated at the interface of the air column, and the generated air bubbles are introduced into the fuel flowing around the air column, so that a bubble-mixed flow is generated. This bubble-mixed flow is injected together with the fuel flow flowing on the outer circumferential side of the bubble-mixed flow.

The injected fuel flow and bubble-mixed flow then turn into a conic spray liquid film that spreads from the center by virtue of the centrifugal force of the swirling flow. The spray liquid film has a diameter that increases in the direction extending away from the nozzle hole 11. Therefore, the spray liquid film is stretched, and becomes thinner. Eventually, the spray liquid film cannot maintain itself as a liquid film, and splits up. The diameter of the spray after the split-up is smaller due to the self-pressurization of microscopic bubbles, and the spray breaks and turns into an ultrafine spray.

Next, the effects to be achieved from the structure of the fuel injection valve 1 of this embodiment are described. In the fuel injection valve 1 of this embodiment, the relay chamber 50 is provided between the first fuel passage 60 and the second fuel passages 70, so that the helical passage can be shortened. Accordingly, pressure loss that occurs when fuel passes through the passage can be reduced, and thus, decreases in the flow speed of the swirling flow to be supplied into the nozzle hole can be reduced. That is, even at the time of activation when fuel pressure is low, a strong swirling flow can be generated, and fuel that contains microscopic bubbles can be injected. As pressure loss of fuel is reduced, driving loss of the pump that pumps out the fuel is reduced, and the costs for increasing the fuel pressure can be lowered. Since only one first fuel passage 60 is provided, the swirling flow is not uniform over an entire circumference of the axis A. However, as the relay chamber 50 is formed over an entire circumference of the axis A, so that the fuel spreads over the entire circumference of the axis A, and the swirling flow becomes uniform over the entire circumference of the axis A.

Further, the fuel injection valve 1 has only one first fuel passage 60, but the flow passage cross-sectional area of the first fuel passage 60 is so large as to secure the fuel flow rate necessary for injection. As the flow passage cross-sectional area of the first fuel passage 60 is large, the wall surface in contact with the fluid becomes smaller than in that a case where more than one passage is formed. Accordingly, flow passage resistance is low, and the pressure loss of the fuel passing through the first fuel passage 60 can be reduced. Thus, the pressure to be applied to fuel in the fuel pump can be lowered, and a decrease in driving loss of the fuel pump and a decrease in cost can be realized. Furthermore, as the pressure of fuel can be lowered, a swirling flow can be generated even at the time of activation when the fuel pressure is low, for example. Accordingly, a spray that contains microscopic bubbles can be formed even at the time of activation, and the spray can be atomized. Also, the gravity center of the triangle that is the cross-sectional shape of the first fuel passage 60 is located well away from the axis A. Accordingly, the swirling diameter of the fuel can be made larger, and the swirling speed can be made higher.

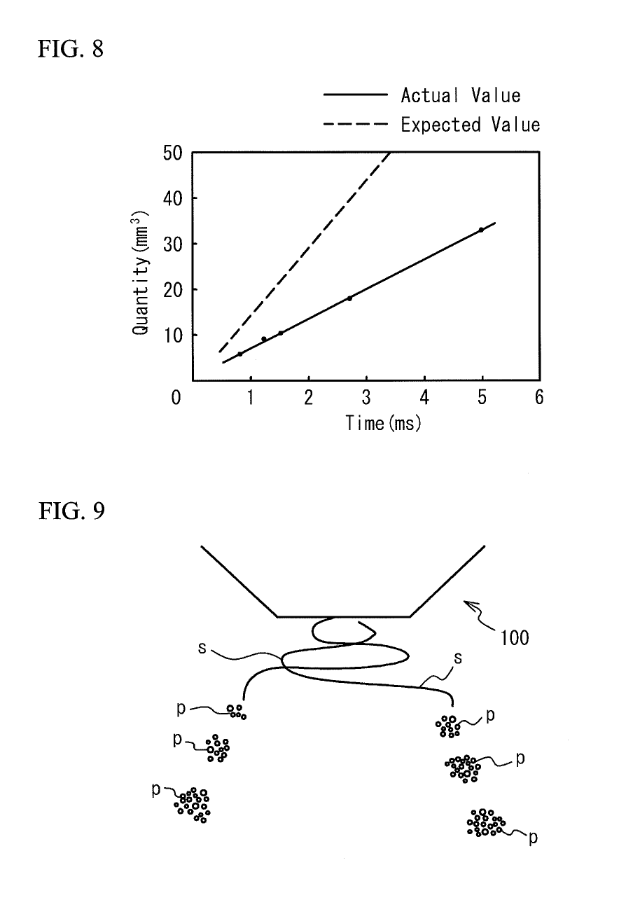

Next, the effects of the second fuel passages 70 are described, in conjunction with a comparison with a fuel injection valve of a comparative example. First, the fuel injection valve 100 of the comparative example is described. FIG. 7 is an explanatory diagram showing the tip of the fuel injection valve 100 of the comparative example in section. Helical fuel passages 101 are formed in the fuel injection valve 100 of the comparative example. The fuel passages 101 are formed with helical grooves 103 formed in a needle 102, and an inner circumferential wall 105 of a nozzle body 104. The maximum lifting E of the needle 102 in the fuel injection valve 100 is approximately 0.06 to 0.1 mm Where the lifting of the needle is 0.1 mm, the width F of a seat space 107 that is formed between a tapered surface 106 on the tip side of the needle 102 and the nozzle body 104 when the needle 102 is lifted up is 0.071 mm. Meanwhile, the depth G of the helical grooves 103 formed in the needle 102 is approximately 0.4 mm. Accordingly, the helical grooves 103 present a high resistance when fuel flows from the fuel passages 101 with deep flow passages into the seat space 107 with a shallow flow passage, and, as shown in FIG. 8, the quantity of fuel to be injected becomes much smaller than an expected value. Further, since the two helical fuel passages 101 are formed in the fuel injection valve 100, the swirling flow s injected from a nozzle hole 108 forms two streams, and the spray becomes patchy, as shown in FIG. 9. As a result, after the fuel is atomized, fuel particles spread in an uneven manner, and there are areas where fuel particles p exist and areas where fuel particles p do not exist.

Next, the effects of the second fuel passages 70 of the fuel injection valve 1 are described. Compared with the first fuel passage 60, the second fuel passages 70 have a smaller width in the direction extending away from the center of rotation of the swirling flow of fuel. Therefore, the flow passage resistance against fuel flowing from the second fuel passages 70 into the seat space 15 becomes lower. Particularly, as the depth of the helical grooves 36 forming the second fuel passages 70 is equal to the seat space 15 at the time of maximum lifting of the needle 20, the resistance against fuel flowing into the seat space 15 can be minimized. Accordingly, a spray that contains microscopic air bubbles can be injected by efficiently generating a high-speed swirling flow and an air column. Also, the quantity of fuel to be injected can be made to approximate an expected value. Further, in the fuel injection valve 1 of this embodiment, the number of second fuel passages 70 that supply fuel into the seat space 15 is made larger than the number of first fuel passages 60, so that the number of outlets of the swirling flow is increased. As the number of outlets of the swirling flow becomes larger, the swirling flow in the nozzle hole 11 become uniform, and the injected spray that contains air bubbles evenly spreads. Thus, the mixed air can be homogeneous. Since four second fuel passages 70 are provided, four streams of the swirling flow can be formed. Accordingly, the spray to be injected becomes more homogeneous than that in the comparative example with two streams, and fine particles of fuel can be evenly distributed. Where the number of second fuel passages 70 is larger, fine particles of fuel can be more evenly distributed. The number of such outlets is preferably three or more. Also, as the second fuel passages 70 have a rectangular cross-section, so that the depth of the helical grooves 36 becomes smaller. With this arrangement, the swirling flow flows into the seat space 15 without any resistance, even at a time when the lifting is small such as the initial stage or the ending stage of lifting of the needle 20. Accordingly, a spray that contains microscopic bubbles can be formed even at a start of fuel injection or at an end of fuel injection. That is, generation of coarse liquid droplets can be reduced.

### Second Embodiment

Next, a second embodiment of the present invention is described. The structure of a fuel injection valve 2 of the second embodiment is substantially the same as the structure of the fuel injection valve 1 of the first embodiment. However, the fuel injection valve 2 differs from the fuel injection valve 1 in the structure of helical grooves 236 formed in a tapered portion 232 of a swirling flow generating member 230. It should be noted that the other aspects of the structure are the same as those of the fuel injection valve 1. Therefore, the same components as those of the fuel injection valve 1 are denoted by the same reference numerals as those used for the fuel injection valve 1, and detailed explanation of them will not be repeated.

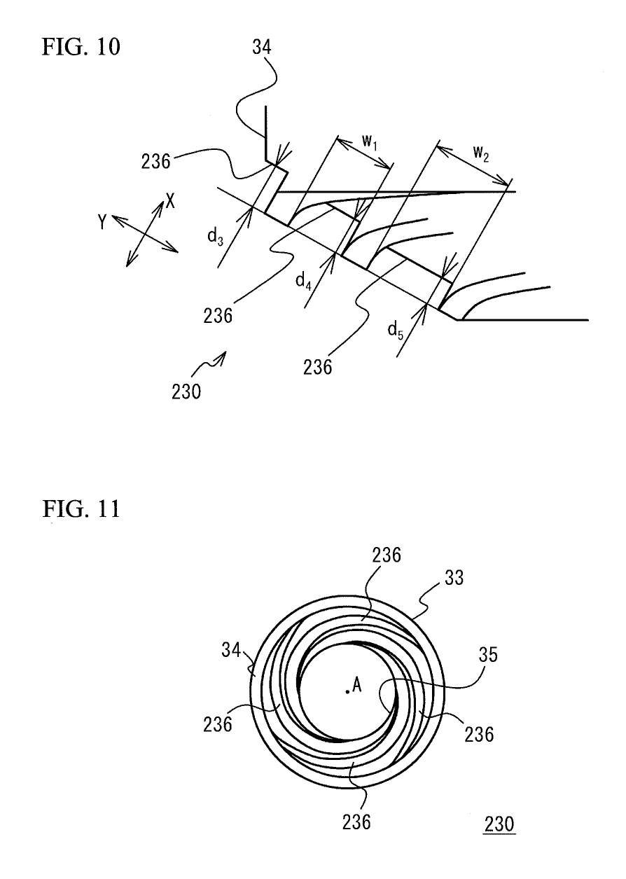

FIG. 10 is an explanatory diagram showing an enlarged view of the helical grooves 236 formed in the swirling flow generating member 230 of this embodiment. FIG. 11 is an explanatory diagram of the swirling flow generating member 230 viewed from the tip side. As shown in FIG. 10, the helical grooves 236 have a greater depth on the side of the notch 34 forming the relay chamber 50, and have a smaller depth at a location closer to the tip side or the seat space 15 (d₃>d₄>d₅). Also, the passage width is smaller on the side of the relay chamber 50 or on the side of the notch 34, and is greater at a location closer to the tip side (w₁<w₂). The helical grooves 236 in the swirling flow generating member 230 and the inner circumferential surface 14 of the nozzle body 10 form the second fuel passages 70. Accordingly, the openings of the second fuel passages 70 on the side of the relay chamber 50 have a greater width in a direction extending away from the center of rotation of a swirling flow of fuel, and have a smaller width in a direction perpendicular to the direction extending away from the center of rotation. The openings of the second fuel passages 70 on the side of the seat portion 12 have a smaller width in the direction extending away from the center of rotation of the swirling flow of fuel, and have a greater width in the direction perpendicular to the direction extending away from the center of rotation. It should be noted that the direction extending away from the center of rotation of the swirling flow of fuel is the depth direction of the helical grooves 236, or the direction indicated by the arrow X in FIG. 10. The direction perpendicular to the direction extending away from the center of rotation is the direction indicated by the arrow Y in FIG. 10. It should be noted that “being perpendicular” entails a range equivalent to manufacturing errors, and does not exclusively mean being perfectly perpendicular. The depth of the helical grooves 236 on the tip side is equal to the seat space 15 at the time of maximum lifting of the needle 20. That is, the width of the openings of the second fuel passages 70 on the side of the seat portion 12 in the direction (the direction of the arrow X) extending away from the center of rotation of the swirling flow of fuel is equal to the seat space 15 at the time of maximum lifting of the needle 20.

As the openings on the side of the relay chamber 50 have a smaller width in the direction (the direction of the arrow Y) perpendicular to the direction extending away from the center of rotation of the swirling flow of fuel, the number of second fuel passages can be made larger. By doing so, the number of outlets of the swirling flow is increased. Accordingly, the swirling flow in the nozzle hole becomes uniform, and the air-fuel mixture becomes homogeneous. Further, as the number of second fuel passages 70 is increased, a larger quantity of fuel can be taken in. Also, as the width of the openings of the second fuel passages 70 on the side of the seat portion 12 in the direction (the direction of the arrow X) extending away from the center of rotation of the swirling flow of fuel is equal to the width of the seat space 15, flow passage resistance can be lowered. By lowering the flow passage resistance in this manner, decreases in flow speed due to pressure loss can be reduced. With this, a swirling flow can be generated in the nozzle hole immediately after injection with low fuel pressure. Accordingly, a spray that contains microscopic bubbles can be formed even in the initial stage of injection. As in this embodiment, the second fuel passages 70 have a rectangular cross-section, so that the passage depth and the passage width of the second fuel passages 70 can be readily changed.

### Third Embodiment

Next, a third embodiment of the present invention is described. The structure of a fuel injection valve 3 of the third embodiment is substantially the same as the structure of the fuel injection valve 1 of the first embodiment. However, the fuel injection valve 3 differs from the fuel injection valve 1 in the structures of a needle 320 and a swirling flow generating member 330. It should be noted that the other aspects of the structure are the same as those of the fuel injection valve 1. Therefore, the same components as those of the fuel injection valve 1 are denoted by the same reference numerals as those used for the fuel injection valve 1, and detailed explanation of them will not be repeated.

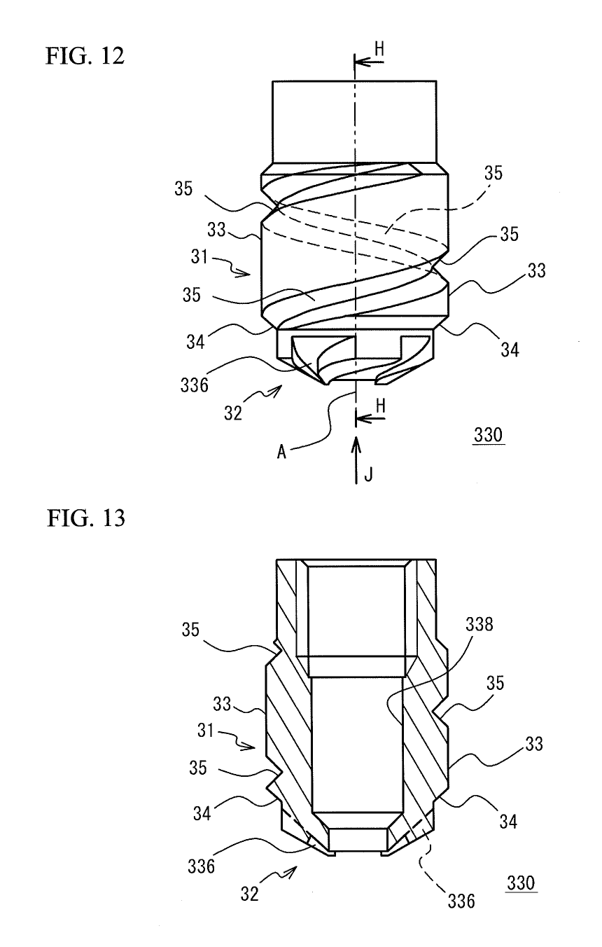

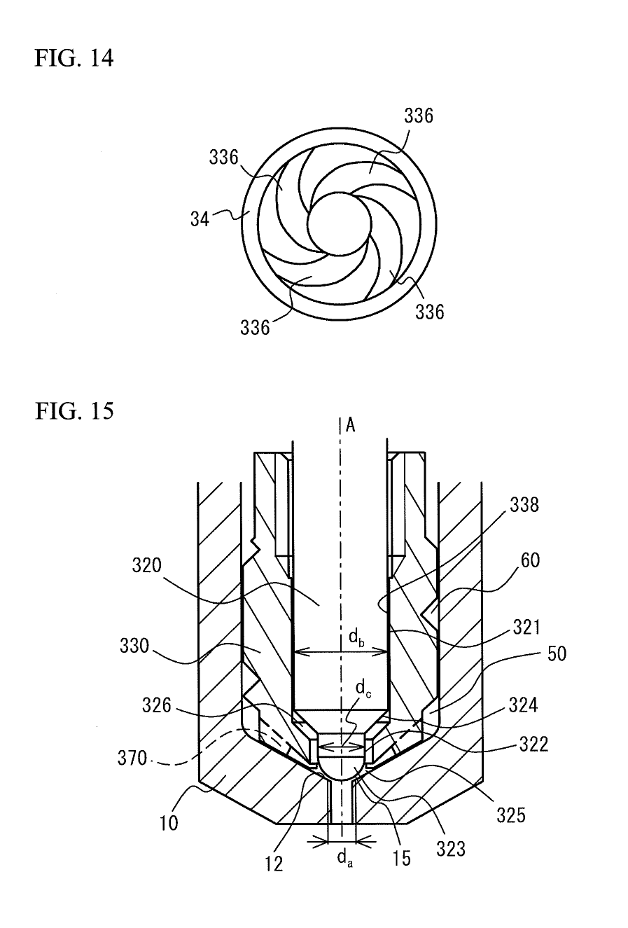

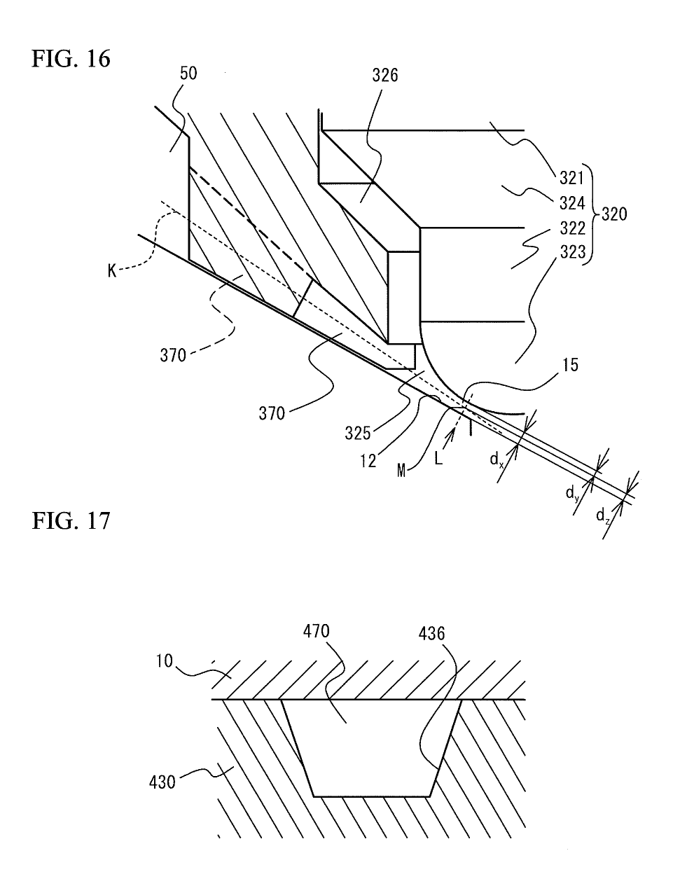

FIG. 12 is an explanatory diagram showing the external appearance of the swirling flow generating member 330 of the fuel injection valve 3. FIG. 13 is an explanatory diagram showing a cross-section taken along the line H-H defined in FIG. 12. FIG. 14 is an explanatory diagram of the swirling flow generating member 330 viewed from the direction indicated by the arrow J in FIG. 12. FIG. 15 is an explanatory diagram showing the tip portion of the fuel injection valve 3 in section. FIG. 16 is an explanatory diagram showing a further enlarged diagram of the seat space 15 shown in FIG. 15. FIGS. 15 and 16 show situations where the lifting of the needle 320 is largest.

As shown in FIGS. 13 and 14, the swirling flow generating member 330 is a hollow cylindrical member. The swirling flow generating member 330 includes the same cylinder portion 31, the same tapered portion 32, and the same notch 34 as those of the swirling flow generating member 30 of the first embodiment. Also, the cylinder portion 31 has the same helical groove 35 as that of the swirling flow generating member 30. Helical grooves 336 that spiral around the axis A are formed in the outer circumferential surface of the tapered portion 32. Four helical grooves 336 are formed. Like the helical grooves 236 formed in the tapered portion 32 of the swirling flow generating member 230 of the second embodiment, the helical grooves 336 are designed to have a greater depth on the side of the notch 34, and have a smaller depth at a location closer to the tip side. Also, the passage width is smaller on the side of the notch 34, and is greater at a location closer to the tip side. As shown in FIG. 15, the swirling flow generating member 330 is incorporated into the nozzle body 10, and is pushed in and secured.

As shown in FIG. 15, the needle 320 is slidably provided in the nozzle body 10. The needle 320 slidably penetrates through the inner circumferential surface 338 of the swirling flow generating member 330. Accordingly, the inner circumferential surface 338 of the swirling flow generating member 330 functions as a needle guide that guides the needle 320. The needle 320 is seated on the seat portion 12 in the nozzle body 10. The sliding direction of the needle 320 matches the direction of the axis A, and the axis A matches the central axis of the needle 320. The needle 320 includes a large-diameter portion 321, a small-diameter portion 322, a tip portion 323, and a tapered portion 324. The large-diameter portion 321 and the inner circumferential surface 338 of the swirling flow generating member 330 form a sliding surface. The small-diameter portion 322 is located closer to the tip than the large-diameter portion 321 is. The tip portion 323 is located closer to the tip than the small-diameter portion 322 is, and is seated on the seat portion 12. The tip portion 323 has a round-shaped portion seated on the seat portion 12. The tapered portion 324 is located between the large-diameter portion 321 and the small-diameter portion 322.

As the portion seated on the seat portion 12 has a round shape, the region where the distance between the seat portion 12 and the needle 320 at the time of lifting of the needle 320 becomes smallest can be narrowed to a point. In reality, the structure is three-dimensional, and a group of dots forms a circle. Accordingly, the narrowing portion that causes flow passage resistance can be minimized. Thus, flow passage resistance can be lowered. The swirling flow can achieve a desired swirling speed at which microscopic bubbles can be formed. When the round-shaped tip portion 323 is seated, the needle 320 is self-aligned, so that the needle 320 can be easily closed. Accordingly, generation of coarse liquid droplets that tend to appear at a start and an end of injection of fuel can be reduced.

Further, the swirling flow generating member 330 and the nozzle body 10 form the relay chamber 50 and the first fuel passage 60, as in the fuel injection valve 1. Also, the helical grooves 336 and the inner circumferential surface 14 of the nozzle body 10 form second fuel passages 370. The second fuel passages 370 apply a flow swirling around the axis A to fuel. The number of second fuel passages 70 is larger than the number of first fuel passages 60. Since the four helical grooves 336 are formed in the swirling flow generating member 330, four second fuel passages 70 are formed in this embodiment. As in the fuel injection valve 2, the openings of the second fuel passages 370 on the side of the relay chamber 50 have a greater width in a direction extending away from the center of rotation of the swirling flow of fuel, and have a smaller width in a direction perpendicular to the direction extending away from the center of rotation. The openings of the second fuel passages 370 on the side of the seat portion 12 have a smaller width in the direction extending away from the center of rotation of the swirling flow of fuel, and have a greater width in the direction perpendicular to the direction extending away from the center of rotation. It should be noted that “being perpendicular” entails a range equivalent to manufacturing errors as in the second embodiment, and does not exclusively mean being perfectly perpendicular.

Also, as shown in FIG. 16, the line K (the dotted line in FIG. 16) extending along the center of a second fuel passage 370 passes through a position M that equally divides the distance dₓ between the seat portion 12 and the needle 320 at a location L where the space between the seat portion 12 and the needle 320 becomes smallest at the time of maximum lifting of the needle 320 (d_{y}=d_{z}).

The fuel flowing in the second fuel passage 370 has the highest speed and the highest flow rate on the line K extending along the center of the second fuel passage 370. Meanwhile, between the exit of the second fuel passage 370 and the nozzle hole 11, the flow passage is narrowest at the location L where the space between the seat portion 12 and the tip portion 323 of the needle 320 is smallest. The position M that equally divides this space is the center of the flow passage. Accordingly, when the line K extending along the center of the second fuel passage 370 passes through the position M, the loss to be caused by flow passage resistance against fuel can be minimized. As described above, with the structure in which the line K extending along the center of the second fuel passage 370 passes through the position M, a high flow rate of fuel to be supplied into the nozzle hole 11 can be secured, and a high-speed swirling flow can be supplied. Thus, the size of bubbles to be formed can be made smaller, and the fuel can be turned into finer particles.

Further, a dispersing chamber 325 is formed between the second fuel passages 370 and the seat portion 12. The dispersing chamber 325 is formed over an entire circumference of the axis A. Since there are four second fuel passages 370, four streams of the swirling flow of fuel flow into the dispersing chamber 325. Formed over an entire circumference of the axis A, the dispersing chamber 325 disperses the swirling flow of fuel supplied from the second fuel passages 370. As the swirling flow becomes homogeneous around the axis A in the dispersing chamber 325, the spray to be injected can be made even more homogeneous.

Further, a suction chamber 326 is formed between the needle 320 and the swirling flow generating member 330. The suction chamber 326 is an annular space that is surrounded by the small-diameter portion 322 of the needle 320, the outer circumferential portion of the tapered portion 324, and the inner circumferential surface 338 of the swirling flow generating member 330. This suction chamber 326 has a volume that increases at the time of lifting of the needle 320, and sucks in fuel from the second fuel passages 370.

When the needle 320 is lifted up, fuel in the second fuel passages 370 tends to flow into both the seat space 15 and the suction chamber 326. Variations in the volume V₂ of the suction chamber 326 that expands and the volume V₁ of the seat space 15 are now described. Where the seat diameter dₐ, the diameter d_{b} of the large-diameter portion 321 of the needle 320, and the diameter d_{c} of the small-diameter portion 322 of the needle 320 are φ1, φ3, and φ1.5, and L₁ represents the amount of lifting, the following equations are satisfied:

$$\begin{matrix}{V}_{2} = \frac{π}{4} ( {d}_{b}^{2} - {d}_{c}^{2} ) {L}_{1} & [ Mathematical Formula 1 ] \\ {V}_{1} = \frac{π}{4} {d}_{a}^{2} {L}_{1} & [ Mathematical Formula 2 ] \\ \frac{{V}_{2}}{{V}_{1}} = \frac{( {d}_{b}^{2} - {d}_{c}^{2} )}{{d}_{a}^{2}} = 6.76 & [ Mathematical Formula 3 ]\end{matrix}$$

According to the equations, when the needle 320 is lifted up, fuel that is 6.75 times more than the fuel flowing into the seat space 15 flows into the suction chamber 326. As the suction chamber 326 is provided, the flow rate of the fuel flowing in the second fuel passages 370 is higher, and a high-speed swirling flow can be generated immediately after lifting of the needle 20. Accordingly, a spray that contains microscopic bubbles can be formed even at a start of injection. Further, when the needle 320 is put back to the original position, fuel in the suction chamber 326 serves as a buffer, and prevents the needle 320 from abruptly closing. In this manner, the needle 320 can be prevented from bouncing. Accordingly, the needle 320 is seated and rests on the seat portion 12. Thus, fuel leakage is reduced, and dripping of fuel after injection can be prevented.

The above described embodiments are merely examples for carrying out the present invention, and the present invention is not limited to them. It should be obvious from the above disclosure that various modifications may be made to those embodiments within the scope of the present invention, and further, other various embodiments can be formed within the scope of the present invention.

For example, in the above described first through third embodiments, helical grooves 436 in the tapered portion 32 of a swirling flow generating member 430 forming second fuel passages 470 may have a trapezoidal cross-section. As the grooves are trapezoidal, the helical grooves can be formed with the use of dies, and accordingly, the manufacture can be conducted by casting. Thus, productivity is increased, and costs can be lowered.

### DESCRIPTION OF LETTERS OR NUMERALS

fuel injection valve 1, 2, 3
nozzle body 10
nozzle hole 11
seat portion 12
pressure chamber 13
seat space 15
needle 20, 320
fuel introduction path 21
swirling flow generating member 30, 230, 330, 430
helical groove (cylinder portion) 35
helical grooves (tapered portion) 36, 236, 336, 436
drive mechanism 40
relay chamber 50
first fuel passage 60
second fuel passages 70, 370, 470
dispersing chamber 325
suction chamber 326

1. A fuel injection valve comprising:
a nozzle body having a nozzle aperture at a tip thereof;
a needle slidably provided in the nozzle body and seated on a seat portion in the nozzle body, a fuel introduction path being formed between the needle and the nozzle body;
a pressure chamber storing fuel introduced through the fuel introduction path;
a relay chamber located closer to a base end side than the seat portion is, and closer to a tip side than the pressure chamber is;
a first fuel passage connecting the pressure chamber to the relay chamber and applying a flow to the fuel, the flow swirling around the needle, the first fuel passage having a helical form; and
second fuel passages connecting the relay chamber to a seat space formed between the seat portion and the needle when the needle is lifted up, the second fuel passages having a helical form,
openings of the second fuel passages on a side of the relay chamber are formed to have a greater width in a direction extending away from the center of rotation of the swirling flow of the fuel, and have a smaller width in a direction perpendicular to the direction extending away from the center of rotation, and
openings of the second fuel passages on a side of the seat portion are formed to have a smaller width in the direction extending away from the center of rotation, and have a greater width in the direction perpendicular to the direction extending away from the center of rotation.

2. The fuel injection valve of claim 1, wherein the number of the second fuel passages is larger than the number of the first fuel passage.

3. The fuel injection valve of claim 1, wherein the second fuel passages have a smaller width in a direction perpendicular to an inner circumferential surface of the nozzle body than the first fuel passage.

4. (canceled)

5. The fuel injection valve of claim 1, wherein a line extending along the center of the second fuel passages passes through a position equally dividing a distance between the seat portion and the needle at a location where a space between the seat portion and the needle at the time of maximum lifting of the needle is smallest.

6. The fuel injection valve of claim 1, wherein the needle has a round-shaped portion seated on the seat portion.

7. The fuel injection valve of claim 1, further comprising
a dispersing chamber dispersing the fuel supplied from the second fuel passage, the dispersing chamber being formed between the second fuel passages and the seat portion.

8. The fuel injection valve of claim 1, further comprising
a suction chamber sucking in the fuel from the second fuel passages when the needle is lifted up.

9. The fuel injection valve of claim 1, wherein the first fuel passage has a triangular cross-section.

10. The fuel injection valve of claim 1, wherein the second fuel passages have a rectangular cross-section.

11. The fuel injection valve of claim 1, further comprising
a swirling flow generating member between the fuel introduction path and the seat portion in the nozzle body,
wherein
the needle slidably penetrates through the swirling flow generating member, and
the first fuel passage and the second fuel passages are formed by helical grooves formed in an outer circumferential surface of the swirling flow generating member and an inner circumferential surface of the nozzle body.

12. The fuel injection valve of claim 11, wherein the helical grooves forming the second fuel passages in the swirling flow generating member have a trapezoidal cross-section.

13. The fuel injection valve of claim 1, wherein a width of the second fuel passage in the direction perpendicular to the inner circumferential surface of the nozzle body becomes smaller towards the sheet space, and the width of the second fuel passage in a direction in which the second fuel passage contacts the inner circumferential surface of the nozzle body becomes larger towards the sheet space.
